(19) United States
(12) Patent Application Publication
(10) Pub. No.: US 2006/0113738 A1
(43) Pub. Date: Jun. 1, 2006

(54) Rack-and-pinion steering mechanism

(76) Inventors: Alexander Zernickel, Herzogenaurach (DE); Stefan Willared, Erlangen (DE)

Correspondence Address: OSTROLENK FABER GERB & SOFFEN, 1180 AVENUE OF THE AMERICAS, NEW YORK, NY, 100368403, US

(21) Appl. No.: 10/542,548

(22) PCT Filed: Dec. 19, 2003
(86) PCT No.: PCT/EP03/14585

§ 371 Date: Jul. 18, 2005

(30) Foreign Application Priority Data
Jan. 24, 2003 (DE) 103 02 766.1

(51) Int. Cl. B62D 3/12

(52) U.S. Cl. 280/93.514; 74/30

(57) ABSTRACT

A pressure piece for a rack and pinion steering system of a motor vehicle having an axial roller bearing arranged in each of the two bearing faces of the pressure piece. The bearing faces lie generally opposed. Rolling friction is realized between the rack and the pressure piece.

### FIELD OF THE INVENTION

The invention relates to a rack and pinion steering system for a motor vehicle, having a steering housing in which a rack is mounted so as to be longitudinally displaceable, the rack having a prismatic form with two bearing faces which are inclined at an angle to the toothing plane and symmetrically with respect to the toothing, and having a pinion, which meshes with the rack, and a pressure piece which is arranged on that side of the rack which lies opposite the engagement side with the pinion and has a back pressure face which rolls without sliding on an associated face of the rack, the pressure piece being prestressed in the axial direction against the rack with the aid of a spring.

### BACKGROUND OF THE INVENTION

Rack and pinion steering systems of this type have been known from the prior art for a relatively long time. In these steering systems, the rack is guided in a steering housing so as to be displaceable in the longitudinal direction. A pinion which is mounted rotatably in the steering housing engages in the toothing of the rack and, when the steering column which is connected fixedly to the pinion so as to rotate with it is rotated, brings about the lateral displacement of the rack, which in turn leads to pivoting of the steered wheels of the motor vehicle via track rods and steering knuckles. The engagement of the pinion into the rack is held without play, in that a pressure piece which is in contact with the rack opposite the pinion presses the rack against the pinion under spring prestress. Here, the pressure piece has to be able firstly to transmit the required pressing force and secondly to offer a bearing surface which does not cause any discernible friction forces or any substantial wear when the rack is displaced on the pressure piece.

A pressure piece which is configured generically in this way is known from DE 82 03 943 U1. According to FIG. 5 of this prior publication, rolling friction is realized between the rack and the pressure piece in such a way that two roller bearings are arranged in the pressure piece. Each of these roller bearings is mounted on an associated bearing journal, which bearing journals are in turn fastened for their part in the pressure piece. The axes of the bearing journals form an enclosed angle of less than 180°, with the result that the bearing outer rings of the two roller bearings form a V-shaped surface in which the rack of V-shaped configuration rests.

Here, it is a disadvantage that this complicated type of roller-mounted pressure piece requires a large amount of radial and axial installation space. Furthermore, a large number of individual components are required which make the installation of the entire pressure piece unit difficult.

### SUMMARY OF THE INVENTION

Proceeding from the disadvantages of the known prior art, it is therefore an object of the invention to provide a pressure piece of the generic type for a rack and pinion steering mechanism, which pressure piece can be manufactured relatively simply.

According to the invention, this object is achieved in accordance with the characterizing part of claim 1 in conjunction with its preamble, in that the pressure piece has two bearing faces which lie opposite one another and are inclined with respect to one another, at least in each case one axial roller bearing with in each case two runner plates and a rolling body set situated between them being arranged in the bearing faces of the pressure piece which lie opposite one another, one runner plate of said axial roller bearing being held fixedly in the pressure piece so as to rotate with it, and the other rotatable runner plate of said axial roller bearing extending inclined at a defined angle with respect to the bearing face of the rack, with the result that a point of contact is formed between the bearing face of the rack and the rotatable runner plate.

The advantage of the solution according to the invention lies, in particular, in the fact that, in order to reduce the friction between the pressure piece and the rack, their design does not have to be changed. It is necessary only to use axial roller bearings in the inclined bearing faces of the pressure pieces which are known per se. Axial roller bearings of this type are available in a wide variety of design variants in different generic types and shapes, as an inexpensive bought-in part. A further advantage of the realization of the rolling friction which is known per se between the pressure piece and the rack consists in that, in comparison with the special designs according to the known prior art, a considerable amount of installation space can be saved. As a result of this, the rack and pinion steering systems according to the invention can be manufactured more inexpensively and more simply.

Further advantageous design variants of the invention are described in claims 2 to 16.

In accordance with claim 2, there is provision for the rack to have a Y-shaped profile. A particularly stable connection between the pressure piece and the rack is realized by this profile of the rack.

It is apparent from claim 3 that the rotatable runner plate is of spherical cap configuration and its convex spherical cap face is in punctiform contact with the bearing face of the rack.

According to other features of the invention in accordance with claims 4 and 5, the axial roller bearing is to be a ball bearing or a needle bearing.

According to a further additional feature in accordance with claim 6, that runner plate of the ball bearing which is arranged fixedly in terms of rotation in the pressure piece is to be configured as a sleeve which engages around the runner plate of spherical cap configuration with its edge.

It is apparent from claim 7 that the axial roller bearing is configured as an axial angular contact needle bearing, the bearing needles of which are guided in a cage.

According to another additional feature in accordance with claim 8, the rotatable runner plate of the ball bearing is to be of mushroom-shaped configuration with a stem and a convex spherical cap face, the stem being accommodated by a sleeve, the needle ring of which surrounds the stem.

It is apparent from claim 9 that the runner plates of the axial roller bearing are connected to one another by a retaining element.

In accordance with claims 10 and 11, the axial roller bearing in the pressure piece is either to be inserted into a blind hole or pressed into a through hole.

In accordance with claim 12, there is provision for the component parts of the axial roller bearings to be manufactured at least partially by a chipless shaping operation.

It is apparent from the second independent claim 13 that the pressure piece has two bearing faces which lie opposite one another and are inclined with respect to one another, at least in each case one axial sliding bearing with in each case two runner plates being accommodated in the bearing faces of the pressure piece which lie opposite one another, one runner plate of said axial sliding bearing being held fixedly in the pressure piece so as to rotate with it, and the other runner plate of said axial sliding bearing extending inclined at a defined angle with respect to the bearing face of the rack, with the result that a point of contact is formed between the bearing face of the rack and the rotatable runner plate.

In accordance with claim 14, there is provision for the rotatable runner plate to be of mushroom-shaped configuration with a stem and a convex spherical cap face, the runner plate which is fixed in terms of rotation to be configured as a sleeve, the base of which is provided with an axially oriented projection, the axially oriented projection being in contact with the base of the stem, and bearing needles being arranged between a circumferential surface of the stem and the sleeve.

According to the third independent claim 15, the object is also achieved in that, in a rack having a cylindrical form which lies opposite the toothing, the pressure piece has two bearing faces which lie opposite one another and are inclined with respect to one another, at least in each case one axial roller bearing with in each case two runner plates and a rolling body set situated between them being arranged in the bearing faces, one runner plate of said axial roller bearing being held fixedly in the pressure piece so as to rotate with it, and the other rotatable runner plate of said axial roller bearing forming a point of contact with the rack.

Finally, according to a last feature of the invention in accordance with claim 16, the cylindrical or arcuate rack is to be provided with a longitudinal recess which is adapted to the profile of the rotatable runner plate. During the design of said longitudinal recess, it should again be ensured that a point of contact is formed between the rack and the rotatable runner plate. More exact guidance of the rack is achieved by this feature and torsional moments are supported reliably, with the result that rotation of the rack is prevented in the axial direction.

The invention will be explained in greater detail using exemplary embodiments which follow.

### BRIEF DESCRIPTION OF THE DRAWINGS

In the drawing:

FIG. 1 shows a partial longitudinal section through a rack and pinion gear mechanism which is configured according to the invention,

FIGS. 2, 3, 4 and 5 show a longitudinal section through pressure piece units which are configured according to the invention, with and without associated rack,

FIGS. 6 and 7 show a longitudinal section through axial roller bearings which are configured according to the invention,

FIGS. 8 and 9 show a longitudinal section through further variants of a pressure piece unit which is configured according to the invention, and

FIG. 10 shows a longitudinal section through a pressure piece unit, with the longitudinal recess of the rack.

### DETAILED DESCRIPTION OF THE DRAWING

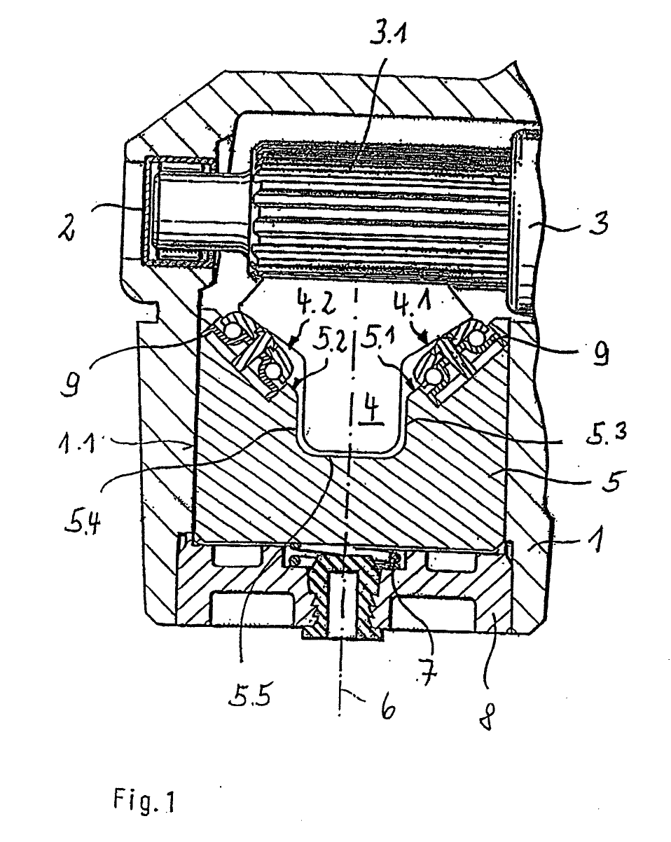

As can be seen from FIG. 1, a steering spindle 3 is mounted in a steering housing 1 via a needle bearing 2 which is arranged on the left and a further roller bearing which cannot be seen on the right, the pinion 3.1 of the steering spindle 3 meshing with a rack 4. When the steering spindle 3 is rotated, the rack 4 is displaced laterally and causes the wheels (not shown) of a motor vehicle to pivot via track rods and steering knuckles (likewise not shown).

The rack 4 is of Y-shaped configuration and has two bearing faces 4.1, 4.2 which are inclined symmetrically at an angle with respect to the toothing plane of the pinion 3.1 and the rack 4. A pressure piece 5 is accommodated in a receptacle hole 1.1 of the steering housing 1 and is arranged so as to be displaceable in said receptacle hole 1.1 along an axis 6. The pressure piece 5 is acted on by a spring 7 on its underside, one end of said spring 7 being supported on a base 8 which is inserted into the stepped receptacle hole 1.1 of the steering housing 1. The pressure piece 5 has a profile which corresponds to the negative of the Y-shaped rack 41 that is to say it is adapted to the profile of the rack 4. It has two bearing faces 5.1, 5.2 which are inclined symmetrically at an angle with respect to one another, merge into two flanks 5.3, 5.4 which drop away vertically and extend parallel to the axis 6, and are connected to one another by the base surface 5.5 which is arranged at right angles to the axis 6.

As FIGS. 1, 2 and 3 show further, in each case one ball bearing 9 is inserted into the inclined bearing faces 5.1, 5.2 of the pressure piece 5, which ball bearing 9 comprises two runner plates 9.1, 9.2 between which bearing balls 9.3 roll. The runner plate 9.2 is pressed fixedly into a blind hole 5.6 and is connected to the movable runner plate 9.1 via a retaining element 9.4 in the form of a pin. As can be seen, in particular, from FIG. 3, the runner plate 9.1 of spherical cap design is arranged with its convex spherical cap face inclined at an angle α, with the result that in each case one point of contact 9.5 is formed between the runner plate 9.1 and the bearing faces 4.1, 4.2. The angle of inclination α is formed by the bearing center axis 9.6 and the normal 9.7 with respect to the bearing faces 4.1, 4.2 of the rack 4. A swirl lever distance which is denoted by a is formed by this tilting by the angle α, which swirl lever distance makes the rotation of the runner plate 9.1 possible in the first place. In the event of lateral displacement of the rack 4, the two movable runner plates 9.1 of the ball bearings 9 are set in rotation about their bearing axis.

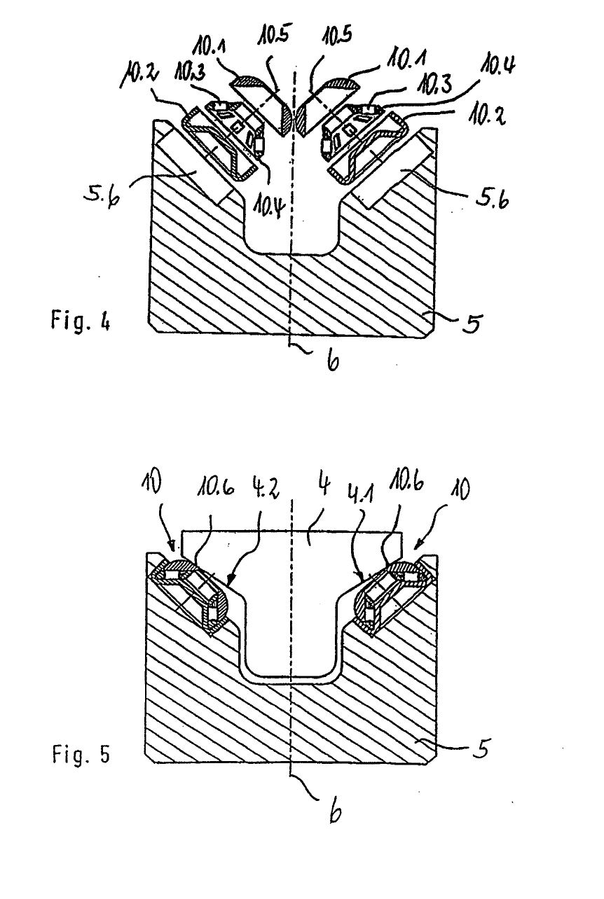

The axial angular contact needle bearing 10 which is shown in FIGS. 4 and 5 again has a movable runner plate 10.1 of spherical cap design and a runner plate 10.2 which is pressed fixedly into the blind hole 5.6 so as to rotate with it. A needle ring which comprises bearing needles 10.3 and bearing cage 10.4 is arranged between the two said runner plates 10.1, 10.2, the bearing needles 10.3 being arranged so as to extend inclined at an angle with respect to the bearing center axis 10.5. The movable running plate 10.1 is again arranged so as to extend inclined by the angle α in the described manner, so that the result is in each case one point of contact 10.6 between the bearing faces 4.1, 4.2 of the rack 4 and the two runner plates 10.1.

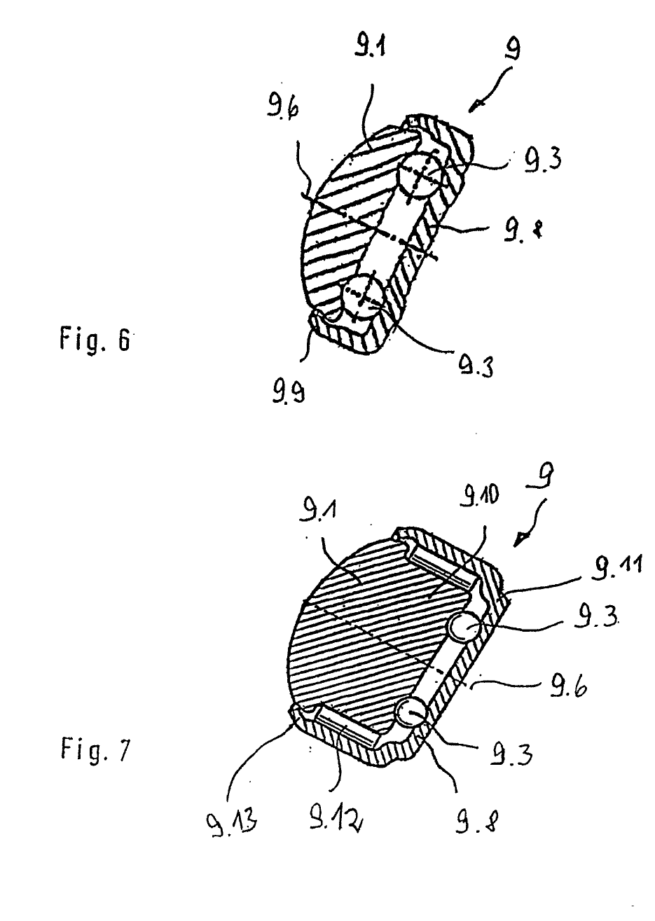

The ball bearing 9 which is shown in FIG. 6 is distinguished by the fact that the runner plate which is arranged fixedly in the pressure piece 5 so as to rotate with it is configured as a sleeve 9.8 which surrounds the runner plate 9.1 of spherical cap configuration with its edge 9.9, with the result that a captive structural unit is formed. Said structural unit comprises the sleeve 9.8, the runner plate 9.1 and the bearing balls 9.3 which are arranged in between.

The ball bearing 9 which is shown in FIG. 7 is distinguished by the fact that the rotatable runner plate 9.1 is of mushroom-shaped configuration with a stem 9, 10 and a convex spherical cap face. The stem 9.10 is accommodated by a sleeve 9.11, the upper edge 9.13 of which encloses the convex spherical cap face of the runner plate 9.1. In this way, a captive structural unit is again formed. Bearing balls 9.3 which absorb the axial pressure are arranged between the base face of the stem 9.10 and the base of the sleeve 9.11. A needle ring 9.12 which guides the runner plate 9.1 in the radial direction is arranged between the circumferential surface of the stem 9.10 and the inner circumferential surface of the edge 9.13 of the sleeve 9.11. Accordingly, there is a combined axial-radial bearing in this exemplary embodiment.

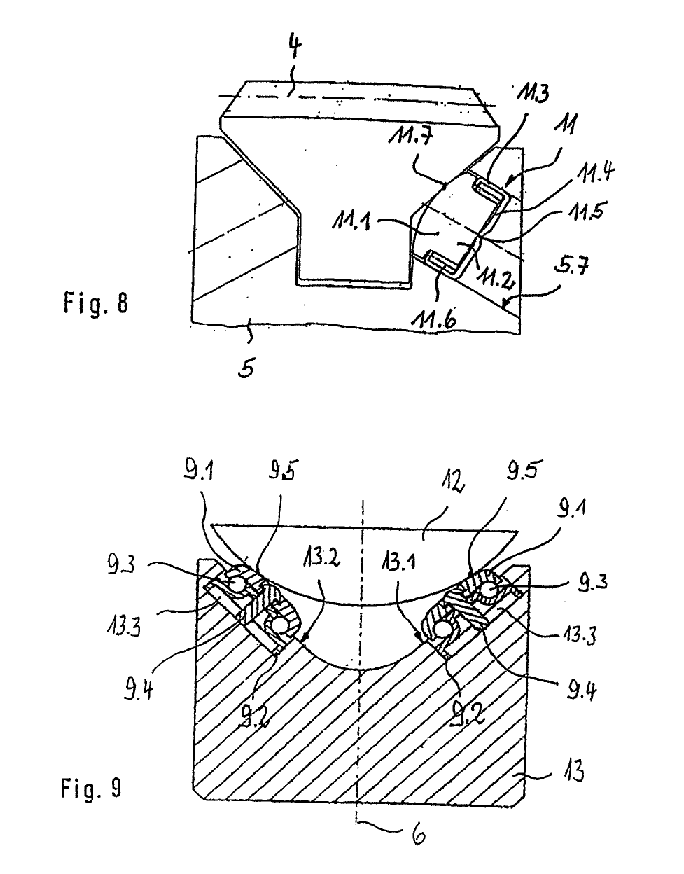

In the rack and pinion steering system which is shown in FIG. 8 and represents the content of the second independent claim 13 and the subordinate claim 14, the axial forces which occur are not absorbed by rolling friction but by sliding friction. The rotatable runner plate 11.1 is of mushroom-shaped design, that is to say it likewise has a convex spherical cap face and a stem 11.2. The runner plate which is arranged fixedly in the through hole 5.7 of the pressure piece 5 so as to rotate with it is configured as a sleeve 11.3, the base 11.4 of which is provided with an axially oriented projection 11.5. The latter is in contact with the base face of the stem 11.2 and thus absorbs the axial forces. The advantage of the through hole 5.7 over the blind hole 5.6 lies in the fact that tolerances can be compensated for in a simple manner by a different position of the introduced bearing. Bearing needles 11.6 are arranged between the circumferential surface of the stem 11.2 and the inner circumferential surface of the sleeve 11.3. It is also the case in this design variant that the rotatable runner plate 11.1 is arranged inclined at the angle α, so that the result is in each case one point of contact 11.7 between the rotatable runner plate 11.1 and the bearing face 4.1, 4.2 of the rack 4. In this way, a combined axial-radial bearing is formed, the axial forces being dissipated by the projection 11.5 and the radial forces being dissipated by the bearing needles 11.6. However, a bearing has been shown only on the right for reasons of simplified illustration.

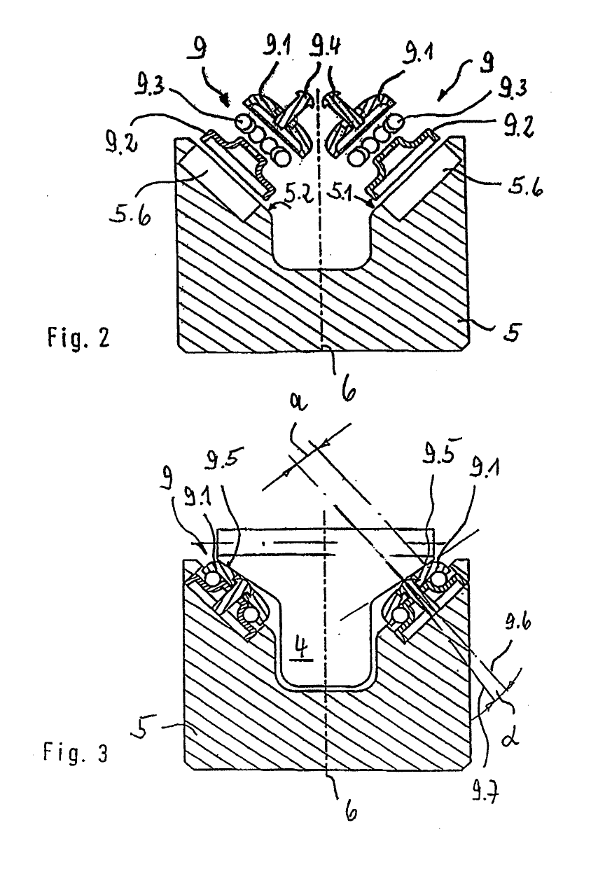

In the rack and pinion steering system which is shown in FIG. 9 and represents the content of the third independent claim 15, the rack 12 has a cylindrical or arcuate design on its side which lies opposite the toothing with the pinion 3.1, that is to say the back of the rack 12 which faces away from the toothing is of arcuate configuration. The associated pressure piece 13 is adapted to the profile of the rack and, as viewed in section, has a U-shaped design, the opposite bearing faces 13.1, 13.2 of which each have a blind hole 13.3 in which in each case one ball bearing 9 is accommodated. The exact description of the bearing 9 can be omitted at this point, as it has already been described in detail in FIGS. 2 and 3. On both sides, in each case one point of contact 9.5 between the rack 12 and the rotatable runner plate 9.1 is formed owing to the arcuate design of the rear of the rack 12. It is also feasible in this case for it to be possible to use an axial sliding bearing instead of an axial roller bearing.

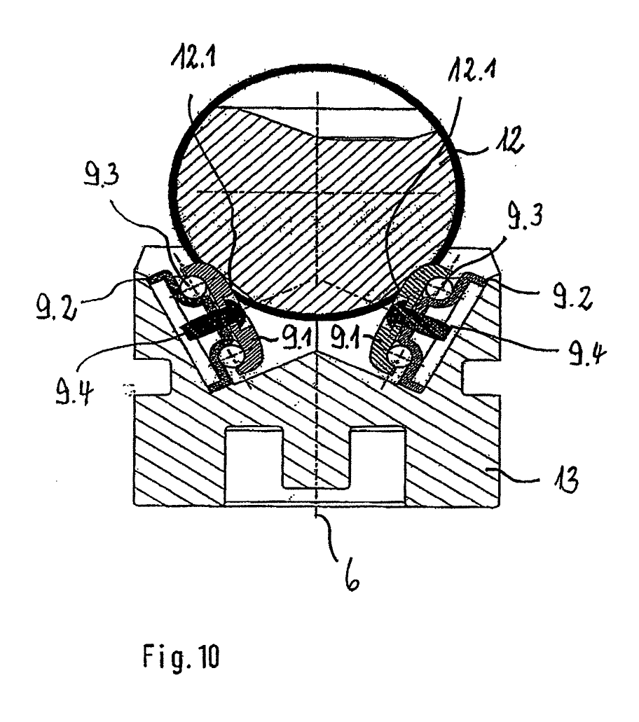

As can be seen from FIG. 10, the rack 12 is provided on both sides with in each case one longitudinal recess 12.1, in which the rotatable runner plate 9.1 of the ball bearing 9 is guided. Here, the profile of the longitudinal recess 12.1 is adapted to the respective profile of the inserted runner plate 9.1. In this way, improved guidance of the rack 12 is realized. Torsional moments which occur are supported reliably, with the result that deformation of the rack in the axial direction is prevented.

### LIST OF DESIGNATIONS

1 Steering housing
1 Receptacle hole
2 Needle bearing
3 Steering spindle
3.1 Pinion
4 Rack
4.1 Bearing face
4.2 Bearing face
5 Pressure piece
5.1 Bearing face
5.2 Bearing face
5.3 Flank
5.4 Flank
5.5 Base surface
5.6 Blind hole
5.7 Through hole
6 Axis
7 Spring
8 Base
9 Ball bearing
9.1 Runner plate
9.2 Runner plate
9.3 Bearing ball
9.4 Retaining element
9.5 Point of contact
9.6 Bearing center axis
9.7 Normal
9.8 Sleeve
9.9 Edge
9.10 Stem
9.11 Sleeve
9.12 Needle ring
9.13 Edge
10 Axial angular contact needle bearing
10.1 Runner plate
10.2 Runner plate
10.3 Bearing needle
10.4 Cage
10.5 Bearing center axis
10.6 Point of contact
11 Axial bearing
11.1 Runner plate
11.2 Stem
11.3 Sleeve
11.4 Base
11.5 Projection
11.6 Bearing needle
11.7 Point of contact
12 Rack
12.1 Longitudinal recess
13 Pressure piece
13.1 Bearing face
13.2 Bearing face
13.3 Blind hole
α Angle of inclination
a Swirl lever

1. A rack and pinion steering system for a motor vehicle, comprising
a pinion having an axis and having a first contact surface around the axis,
a rack having a longitudinal direction across the axis of the pinion and the rack being mounted to be displaceable along the longitudinal direction thereof; the rack having a second contact surface that engages the first contact surface, the rack having a prismatic form including two bearing faces which are inclined at an angle to the engagement of the first and second contact surfaces and being symmetrical with respect to the first contact surface along the axis;
the rack having a third side opposite the second contact surface; bearing faces on the third side;
a pressure piece arranged on the third side of the rack, the pressure piece having a back pressure face which rolls without sliding on the bearing faces on the third side of the rack, the pressure piece being prestressed in the axial direction against the rack; the pressure piece having two of the bearing faces which lie generally opposed to one another and are inclined with respect to one another;
at least one axial roller bearing at each bearing face, the roller bearing comprising two spaced apart runner plates and a rolling body set situated between the runner plates, one runner plate of each axial roller bearing being held in the respective pressure piece so as to rotate with and the other rotatable runner plate of the axial roller bearing extending inclined at a defined angle α with respect to the bearing face, the angle α defining a point of contact between the bearing face of the rack and the rotatable runner plate, the contact point being less than the entire width of the other runner plate along the axis of the plate.

2. The rack and pinion steering system as claimed in claim 1, wherein the rack has a generally Y-shaped profile.

3. The rack and pinion steering system as claimed in claim 1, wherein the rotatable runner plate has a spherical cap configuration having a convex spherical cap face in punctiform contact with the bearing face of the rack.

4. The rack and pinion steering system as claimed in claim 1, wherein the axial roller bearing is a ball bearing.

5. The rack and pinion steering system as claimed in claim 1, wherein the axial roller bearing is a needle bearing.

6. The rack and pinion steering system as claimed in claim 4, wherein that runner plate of the ball bearing which is fixed in terms of rotation in the pressure piece is configured as a sleeve having an edge which engages around the runner plate of spherical cap configuration.

7. The rack and pinion steering system as claimed in claim 5, wherein the axial roller bearing is configured as an axial angular contact needle bearing including bearing needles, and a cage guided at the needles for the needles bearing.

8. The rack and pinion steering system as claimed in claim 4, wherein the rotatable runner plate of the ball bearing has a mushroom-shaped configuration including a stem and a convex spherical cap face, a sleeve accommodating the stem and
a needle ring which surrounds the stem.

9. The rack and pinion steering system as claimed in claim 1, further comprising a retaining element connecting the runner plates of the axial roller bearing to one another.

10. The rack and pinion steering system as claimed in claim 1, wherein the pressure piece has a blind hole; and the axial roller bearing is inserted into the blind hole of the pressure piece.

11. The rack and pinion steering system as claimed in claim 1, wherein the pressure piece has a through hole; and the axial roller bearing is pressed into the through hole in the pressure piece.

12. The rack and pinion steering system as claimed in claim 1, wherein the parts of the axial roller bearings are manufactured at least partially by a chipless shaping operation.

13. A rack and pinion steering system for a motor vehicle, comprising
a pinion having an axis and having a first contact surface around the axis,
a rack having a longitudinal direction across the axis of the pinion and the rack being mounted to be displaceable along the longitudinal direction thereof; the rack having a second contact surface that engages the first contact surface, the rack having a prismatic form including two bearing faces which are inclined at an angle to the engagement of the first and second contact surfaces and being symmetrical with respect to the first contact surface along the axis;
the rack having a third side opposite the second contact surface; bearing faces on the third side;
a pressure piece arranged on the third side of the rack, the pressure piece having a back pressure face which slides on the bearing faces which are on the third side of the rack, the pressure piece being prestressed in the axial direction against the rack; the pressure piece having two of the bearing faces which lie generally opposed to one another and are inclined with respect to one another;
at least one axial sliding bearing, at each bearing face, the axial sliding bearing comprising two runner plates accommodated in the bearing faces of the pressure piece which bearing faces lie opposed to one another, one of the runner plates of the axial sliding bearing being held in the pressure piece so as to rotate with it, and the other rotatable runner plate of the axial sliding bearing extending inclined at a defined angle α with respect to the bearing face of the rack, to define a point of contact between the bearing face of the rack and the rotatable runner plate.

14. The rack and pinion steering system as claimed in claim 13, wherein the runner plate has a mushroom-shaped configuration including a stem and a convex spherical cap face, the runner plate which is fixed in terms of rotation is configured as a sleeve, the sleeve has a base provided with an axially oriented projection, and the axially oriented projection being in contact with the base of the stem.

15. A rack and pinion steering system for a motor vehicle, comprising a pinion having an axis and having a first contact surface around the axis
a rack having a longitudinal direction across the axis of the pinion and the rack being mounted to be displaceable along the longitudinal direction thereof; the rack having a second contact surface that engages the first contact surface, the rack having a back side which lies opposite the second contact surface thereof, the second contact surface having an arcuate form,
a pressure piece arranged on the back side of the rack which lies opposite the second contact surface thereof, the pressure piece has a back pressure face which rolls without sliding on the rack, the pressure piece being prestressed in an axial direction thereof and against the rack;
the pressure piece having two bearing faces which lie generally opposed to one another and are inclined with respect to one another;
for each bearing face, an axial roller bearing comprising two spaced apart runner plates and a rolling body set situated between the runner plates and arranged in the respective bearing faces, one runner plate of the axial roller bearing being held in the pressure piece so as to rotate with the pressure piece, and the other rotatable runner plate of the axial roller bearing is shaped and oriented to have a point contact with the rack.

16. The rack and pinion steering system as claimed in claim 15, wherein the rack has a longitudinal recess which is adapted to the profile of the rotatable runner plate.

17. The rack and pinion steering system as claimed in claim 1, wherein the first and second contact surfaces are toothed and the toothing thereof are in mesh.

18. The rack and pinion steering system as claimed in claim 1, further comprising a spring operable to prestress the pressure piece.

19. The rack and pinion steering system as claimed in claim 13, wherein the first and second contact surfaces are toothed and the toothing thereof are in mesh.

20. The rack and pinion steering system as claimed in claim 14, further comprising the stem has a circumferential surface; and bearing needles arranged between the circumferential surface of the stem and the sleeve.

21. The rack and pinion steering system as claimed in claim 15, wherein the first and second contact surfaces are toothed and the toothing thereof are in mesh.

22. The rack and pinion steering system as claimed in claim 15, further comprising a spring operable to prestress the pressure piece.
